(19) United States
(12) Patent Application Publication
(10) Pub. No.: US 2009/0317243 A1
(43) Pub. Date: Dec. 24, 2009

(54) HIGH REFLECTIVITY INFRARED COATING APPLICATIONS FOR USE IN HIRSS APPLICATIONS

(75) Inventors: Andrew Jay SKOOG, West Chester, OH (US); Jane Ann MURPHY, Franklin, OH (US); John Michael JASANY, Cincinnati, OH (US); Mariah Dawn SENTER, Mason, OH (US)

Correspondence Address: MCNEES WALLACE & NURICK LLC, 100 PINE STREET, P.O. BOX 1166, HARRISBURG, PA, 17108-1166, US

(73) Assignee: GENERAL ELECTRIC COMPANY, Schenectady, NY (US)

(21) Appl. No.: 11/743,303

(22) Filed: May 2, 2007

Related U.S. Application Data
(62) Division of application No. 10/972,553, filed on Oct. 25, 2004, now abandoned.

(51) Int. Cl. F02C 7/24

(52) U.S. Cl. 415/177

(57) ABSTRACT

The present invention is a hover infrared suppression system for a gas turbine engine comprising a hover infrared suppression system having an upstream first stage, a second stage downstream of the first stage and a third stage downstream of the second stage, the engine operating at a temperature sufficient to cause the hover infrared suppression system to emit infrared radiation. The present invention further comprises a high reflectivity coating applied over a preselected area of at least one of the stages of the hover infrared suppression system to reduce the infrared radiation emitted from the engine, the high reflectivity coating being fired after application.

### CROSS-REFERENCE TO RELATED APPLICATIONS

This application is related to U.S. Pat. No. 6,720,034 B2, issued on Apr. 13, 2004, entitled “METHOD OF APPLYING A METALLIC HEAT REJECTION COATING ONTO A GAS TURBINE ENGINE COMPONENT,” assigned to the assignee of the present invention and which is incorporated herein by reference in its entirety and U.S. application Ser. No. 10/726,361, Attorney Docket No. 13DV-13637, filed on Dec. 3, 2003, entitled “SPRAYABLE NOBLE METAL COATING FOR HIGH TEMPERATURE USE DIRECTLY ON AIRCRAFT ENGINE ALLOYS,” assigned to the assignee of the present invention and which is incorporated herein by reference in its entirety.

### FIELD OF THE INVENTION

The present invention is directed to a low emissivity, or high reflectivity, coating for use in HIRSS applications, and specifically to the use of the low emissivity, or high reflectivity, coatings for use in T-700 helicopter engines employing HIRSS hardware.

### BACKGROUND OF THE INVENTION

Hover Infrared Suppression Systems (HIRSS) were developed to reduce the infrared (IR) signature of helicopter engines. These systems have been employed to reduce the infrared emissions of the exhaust from engines employed in helicopter applications, such as the General Electric T-700 engine employed in helicopter designs including, the Black Hawk UH-60, the Apache AH-64 and the AH-1, among others, in use by the U.S. Military. Because the “threat systems” (heat seeking missile technology, for example) is constantly improving, and because engine temperatures are constantly increasing, resulting in higher exhaust temperatures, it is necessary to further improve the IR signature of such engines to neutralize these threats.

Infrared suppression systems such as the HIRSS are known and have been in use for some time. U.S. Pat. No. 6,253,540 to Chew et al. assigned to the assignee of the present invention and which is incorporated herein by reference in its entirety, discloses an apparatus for suppressing infrared radiation emitted from the aft end of a gas turbine engine. The system features a mechanical arrangement of baffles connected together to mix hot and cool gas flow together to affect the line-of-sight infrared radiation signature of the exhaust. Additional improvements have been made to these HIRSS. While these improvements have been effective in suppressing infrared radiation, the continued increase in engine operating temperature as well as improvements in detection by advances in threat systems have made engines operating even with improved HIRSS systems increasingly vulnerable. What is needed is a HIRSS system that suppresses infrared radiation emitted by engines used in helicopter technology such as the GE T-700 engines. The present invention fulfills this need, and further provides related advantages.

### SUMMARY OF THE INVENTION

The present invention utilizes a low emissivity (Low-E or highly reflective) coating applied to the exhaust baffles of HIRSS systems. The Low-E coating reflects infrared radiation (IR) from the hot gas exhaust stream back upstream into the engine for subsequent dissipation. This lowers the overall temperature of the structure or additionally lowers radiation off backside or out back of the exhaust. IR performance of existing HIRSS systems can be improved, making them much less detectable to threat systems that utilize infrared (IR) detection techniques to track and locate aircraft utilizing such engines, and to target them for destruction.

Heated bodies radiate energy. The amount of energy emitted by a particular material is a characteristic of the material and depends on the temperature of the material. The amount of radiation emitted by a heated body is its emissivity, which can be measured at various temperatures. As metals are heated, the wavelength at which energy is emitted becomes shorter. Heated metal surfaces emit radiation in the IR range of 2-12 microns when heated sufficiently. The present invention is a coating applied to metal surfaces that lowers the emissivity of the surface to which it is applied so that in the temperature range of operation, for the gas turbine engines of the present invention, 1800° F. and lower, the surface to which the coating is applied is altered by changing its emissivity so that significantly more energy is reflected in the infrared wavelength range in the temperature range of operation, reducing the operating temperature of the component to which the coating is applied as less energy is absorbed. Thus, the present invention reduces the infrared emissions from the engine, thereby making detection by infrared detection devices more difficult, thereby reducing the infrared signature of the invention.

The Low-E, or highly reflective, coating is applied to specific rear portions of the engine, so that the materials comprising the structures facing inwardly reflect a significant portion of incident IR as they are exposed to the operating temperatures of the engine. The component to which the reflective coating is applied typically is a nickel-base superalloy. These structures include, but are not limited to, baffles that have been designed to mix cool and hot air.

As applied, the effective coating composition for suppression of IR desirably includes gold and platinum pigments in the form of finely divided particles and/or metal salts which precipitate atomic size gold and platinum metal particles of a metal such as platinum, gold or alloys of these metals such as platinum-gold alloys onto the article surface. The carrier is a liquid that allows the metallic pigment to flow through an air-spray system and then aids in initially adhering the metallic pigment to the surface of the component prior to firing. Organic carriers are preferred. The present approach may be used to deposit an alloyed metallic coating, as distinct from a pure metallic coating.

The material is applied as a thin coating over the surface of the component, such as baffles. A method of applying a heat-rejection coating comprises the steps of supplying a baffle comprising a high temperature material, cleaning the baffle, lightly buffing the baffle, spraying a reflective coating mixture onto the component, the reflective coating mixture comprising a pigment, comprising gold and platinum, and a carrier, and firing the component having the reflective coating mixture thereon to form a reflective coating on the component. The reflective coating is preferably applied by air-assisted spraying, although airless, high-velocity low pressure (HVLP) spraying, brushing, and decal transfer may be used. Air-assisted spraying is a technique comparable to the familiar spraying of ordinary paint, and is typically performed at room temperature using an air-spray-gun type device. The material to be sprayed, here the reflective coating and possibly the ceramic barrier coating, are not significantly heated during the spray process (although they are heated subsequently in the firing step). Airless and air-assisted spraying are to be contrasted with other spray techniques used to deposit other types of coatings in the gas turbine industry, such as vacuum plasma spraying and air plasma spraying, which are not within the scope of the invention. Plasma spray techniques are performed by heating the material to be sprayed to high temperatures and then forcing the heated material against the surface with a flow of the spray gas. Air-assisted spraying is also to be contrasted with other types of deposition techniques such as chemical vapor deposition (CVD), physical vapor deposition (PVD), and electrodeposition, all of which require complex deposition apparatus, and all of which are outside the scope of the invention. Most of these other application techniques are limited as to the size of the articles that may be readily coated, because they require special chambers or other types of application apparatus. Airless or air-assisted spraying, which are typically an ambient temperature process, on the other hand, are not limited by these considerations, and therefore may be readily used on a wide variety of sizes and shapes of components, such as baffles.

The reflective coating of the present invention is quite thin, both to conserve the expensive metal and to avoid a coating that adversely affects the properties of the underlying component. Because the reflective coating is thin, it is preferred to specify its quantity by a real weight rather than by thickness. Most preferably, the reflective coating is present in an amount of about 0.00275 to about 0.00475 grams per square inch of the component surface being coated. Because of the location in the exhaust nozzle of the engine, the coating material, in order to be survivable, in addition to being able to reflect the infrared radiation, must be erosion resistant as the gases passing over the coating travel at a high velocity. The coating material also must be resistant to environmental damage such as corrosion and/or oxidation at high temperatures, as the exhaust gases of a gas turbine engine includes, in addition to the products of combustion, all of the impurities that are in jet fuel, such as, for example, JP-8. The temperature that the coating of the present invention, as applied to the HIRSS of the present invention is expected to experience is up to about 1200° F. with temporary transients up to 1400° F. Thus, the coating formulation is engineered to survive temperatures of about 1400° F. without experiencing degradation in performance.

The component surface may be pre-treated prior to the application of the reflective coating mixture, so that the reflective coating mixture is sprayed onto the pre-treated surface. Pre-treatments include one or both of (a) polishing the component surface and (b) degreasing the component surface. However, no such pre-treatment is required for the present invention on new component hardware that is grease and oil free.

The component, after application of the coating, is allowed to dry. When a solvent is used, the solvent is evaporated either at ambient or by heating at low temperature. The coated surface is fired at an elevated temperature sufficient to allow the coating to form a metallurized bond with the surface.

The present invention provides a heat-rejection coating that is readily and inexpensively applied to a metallic substrate article such as a superalloy article. The heat-rejection coating aids in reducing the heating of the article by reflecting incident radiant energy. The present approach is readily utilized with large articles, such as baffles, that do not fit into the deposition chambers required for prior approaches.

A method of applying a heat-rejection coating comprises the steps of supplying a metallic component of a gas turbine engine, optionally pre-treating the surface, applying a reflective-coating composition onto the component, the reflective-coating mixture comprising gold and platinum and a carrier when sprayed, and firing the component having the reflective-coating mixture thereon to form a gold/platinum reflective coating on the component. The component to which the reflective coating is applied is a metallic alloy capable of surviving high temperature exposure. Examples of components to which the coating may be applied includes a large rear baffle and parts that experience radiation in the combustion and exhaust systems.

While surface pretreatment is not required by the present invention, the component surface may be polished and/or degreased prior to the application of the reflective-coating mixture, so that the reflective-coating mixture is air sprayed onto the polished and/or degreased surface. The present invention does not require a ceramic barrier coating.

The present invention is also a method of applying a heat-rejection coating comprising the steps of: supplying a metallic exhaust component of a gas turbine engine, applying a reflective-coating mixture onto the component, wherein the reflective-coating mixture comprises pigment selected from the group consisting of gold, gold alloys, platinum, platinum alloys, and combinations thereof, and a reflective-coating mixture carrier, and wherein the step of applying is accomplished by a method selected from the group consisting of air-assisted spraying, airless spraying, brushing, and decal transfer; and firing the component having the reflective-coating mixture thereon to form a reflective coating on the component.

The present invention is also a hover infrared suppression system for a gas turbine engine comprising a hover infrared suppression system having an upstream first stage, a second stage downstream of the first stage and a third stage downstream of the second stage, the engine operating at a temperature sufficient to cause the hover infrared suppression system to emit infrared radiation. The system further comprises a high reflectivity coating applied over a preselected area of at least one of the stages of the hover infrared suppression system to reduce the infrared radiation emitted from the engine, the high reflectivity coating being fired after application.

The present invention is also a large forward baffle for a hover infrared suppression system comprising a large forward baffle having a fore face. The system further comprising a noble metal coating on a preselected area of the fore face, the noble metal coating being present in an amount in the range of about 0.00275 to about 0.00475 grams per square inch of the preselected area.

An advantage of the present invention is that the coating improves the IR performance of the materials to which it is applied, thereby reducing or eliminating the likelihood that the material will emit infrared radiation. This, in turn, reduces the prospect of detection of the engine and hence the aircraft by IR detection devices and weapons based on IR detection.

Another advantage of the present invention is that the coating can be applied to existing HIRSS of engines so equipped and other exhaust components and immediately improve the IR performance of such engines without the need to upgrade the mechanical components of the engines. Alternatively, the coating of the present invention can be applied to any newly improved HIRSS and other exhaust components of engines, thereby increasing the temperature range over which the engine can perform with decreased likelihood of detection by IR-seeking devices.

Another advantage of the present invention is that it can readily be applied to as-manufactured engine components with little preparation, except for cleaning. The coating of the present invention can conveniently be applied by spraying, although other methods such as brushing or dipping can also be used.

Still another advantage of the present invention is that the material applied to the HIRSS and other components of the exhaust system is readily repairable if it should be subject to foreign object damage (FOD) or damage as a result of use over time. Repair can be readily accomplished in the field. Repair using the present invention requires reprocessing the component through a fire cycle.

Other features and advantages of the present invention will be apparent from the following more detailed description of the preferred embodiment, taken in conjunction with the accompanying lower cost and improved performance drawings which illustrate, by way of example, the principles of the invention.

### BRIEF DESCRIPTION OF THE DRAWINGS

FIG. 1 depicts a cross-sectional schematic view of the prior art infrared suppression system as set forth in U.S. Pat. No. 6,253,540.

FIG. 2 is a cross-sectional view, depicting the mechanical configuration of the present HIRSS.

FIG. 3 is an exploded view of the present HIRSS.

FIG. 4 is a perspective view of the HIRSS of the present invention, with a view into the first stage.

FIG. 5 is a cut-away view of the HIRSS of the present invention, showing the assembled deswirler and the baffle assembly.

FIG. 6 is a perspective view of a baffle assembly.

FIG. 7 is a block flow diagram of a preferred approach for practicing the invention.

FIG. 8 is a schematic sectional view of a coated component.

FIG. 9 is a graph of hemispherical reflectance at 10°, 30°, 50°, and 70° reflection angles for as-received INCONEL® 625 at ambient temperature.

FIG. 10 is a graph of hemispherical reflectance at 10°, 30°, 50°, and 70° reflection angles for as-received INCONEL® 625 exposed to 950° F. for 50 hours.

FIG. 11 is a graph of hemispherical reflectance at 10°, 30°, 50°, and 70° reflection angles for as-received INCONEL® 625 plus the fired reflective coating exposed to 1200° F. for 1 hour.

### DETAILED DESCRIPTION OF THE INVENTION

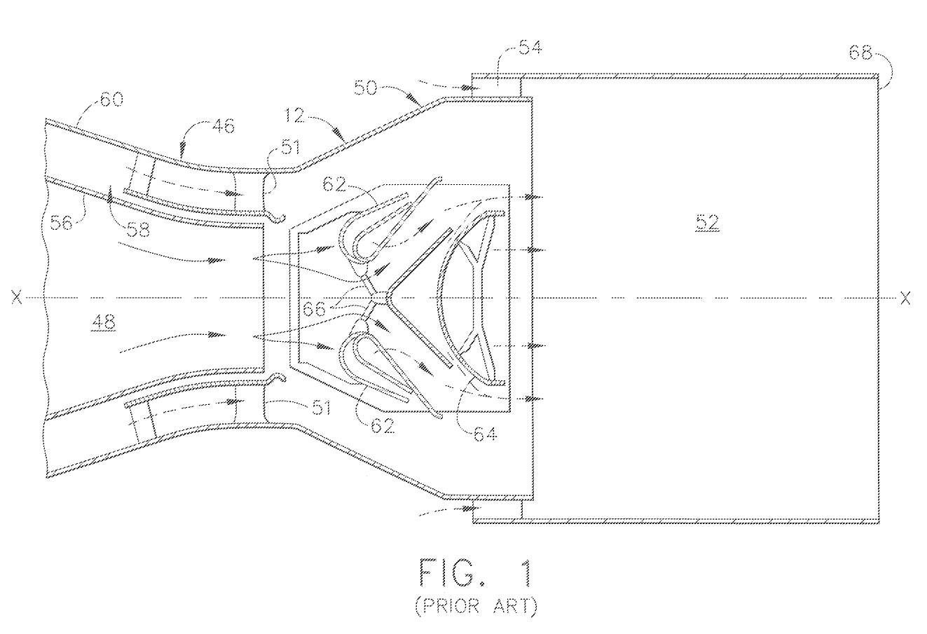

The present invention is directed for use a gas turbine engine of the conventional turboshaft type, but its use is not so limited, and it may be used with other types of gas turbine engines such as turbofan and turboprop engines. FIG. 1 depicts a cross-sectional schematic view of a prior art infrared suppression system for use in a gas turbine engine of the conventional turboshaft type, such as the GE T-700, wherein the power turbine shaft may be connected to drive rotor blades of a helicopter. This prior art infrared suppression system utilizes a mechanical arrangement of baffles to achieve the improvement in IR performance to mix hot and cool gases while eliminating line of sight IR so as to improve engine performance. The system achieves its improved IR performance without the use of Low-E materials. While the system provided an acceptable solution for its time, the current infirmities with the system are discussed above. FIG. 1 is set forth fully in U.S. Pat. No. 6,253,540, ('540 patent) and the numeric identification of features is as set forth in the '540 patent. The baffle system breaks down a single hot exhaust gas flow stream into four distinct flow streams. In the process of breaking down the single flow stream, the baffle draws in cooling air into the opening while blocking the line of sight of IR from the rear of the exhaust. The improved baffle of the present invention is provided as a readily removable module, with the coating of the present invention applied.

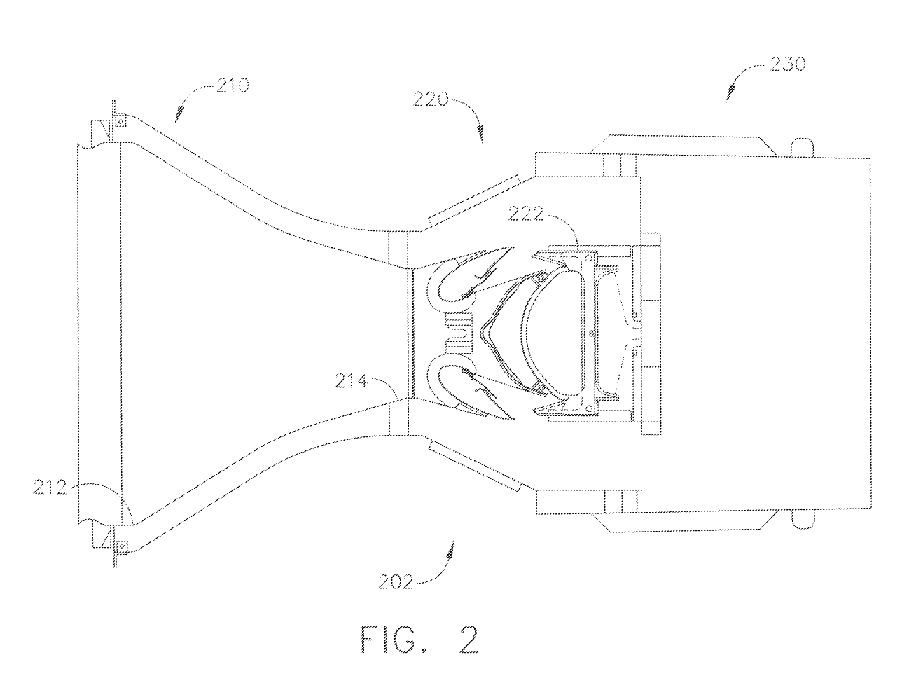

FIG. 2 is a cross section of the current HIRSS design 202. The current HIRSS includes the same overall configuration as the prior art IR suppression system of FIG. 1, although the specific features of the components are different. The HIRSS design of FIG. 2 includes a first stage 210, a second stage 220, and a third stage 230. The first stage includes a transition section having a circular cross section 212 at the upstream end, which receives the hot gases of combustion exiting the turbine section of the engine. The first stage transitions to a rectangular cross section 214 at its downstream end where it mates with the second stage 220. The second stage 220, intermediate between the first stage 210 and the third stage 230, includes the baffle system 222. The final stage 230 is a downstream duct through which the exhaust gases leave the engine and are exhausted into ambient air.

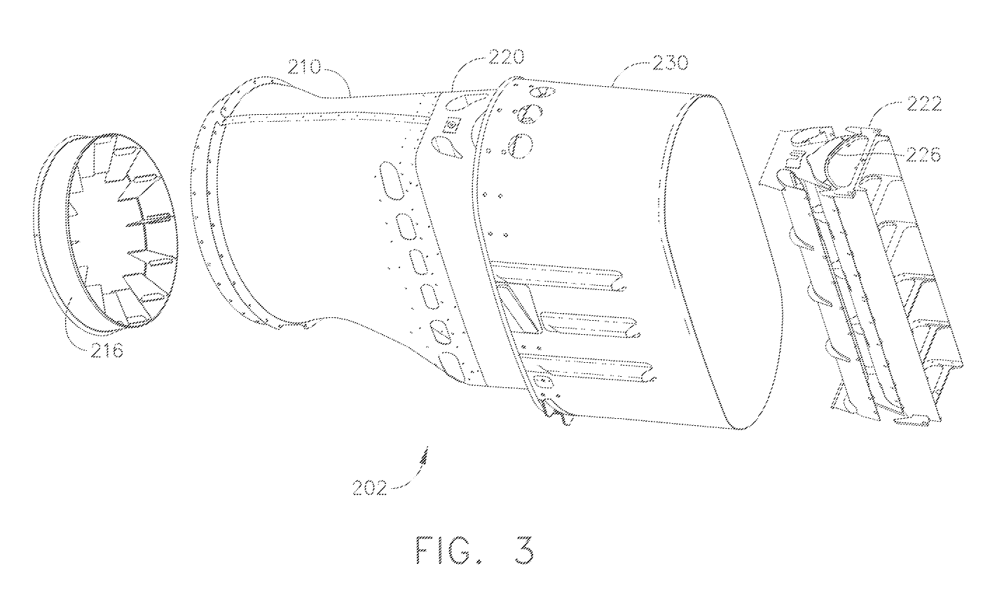

Referring now to FIG. 3, there is shown an exploded view of the HIRSS of the present invention. The HIRSS of the present invention includes a stage one deswirler 216. The deswirler 216 directs the exhaust flow from the turbine portion of the engine, assisting in the mixing of the air. This mechanical component is not affected by the improvements provided by the present invention. Removable baffle assembly 222 is also shown.

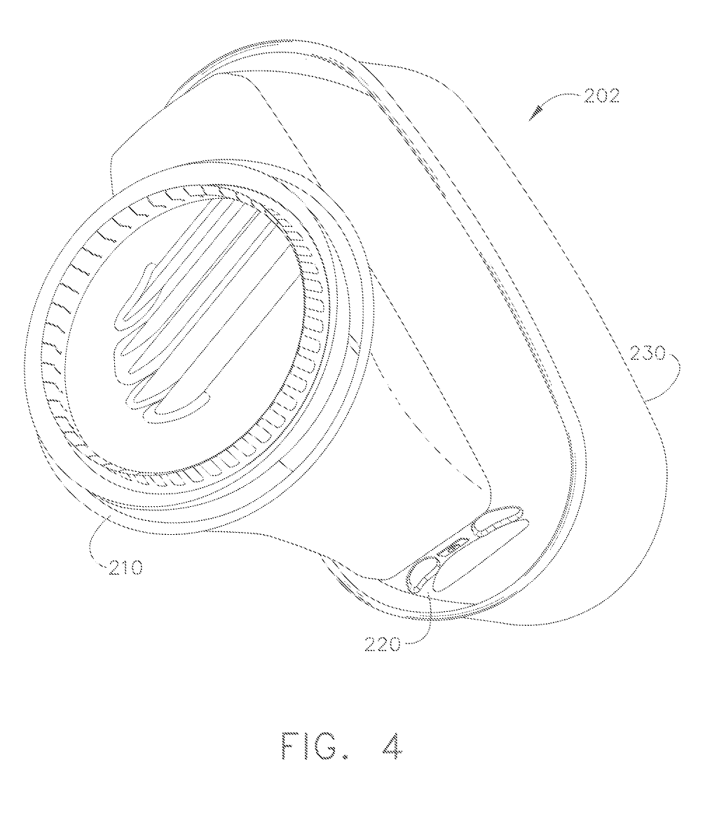

FIG. 4 is a perspective view of the HIRSS of the present invention, showing the HIRSS from the inlet end, that is, where the exhaust from the turbine portion of the engine enters the first stage 210.

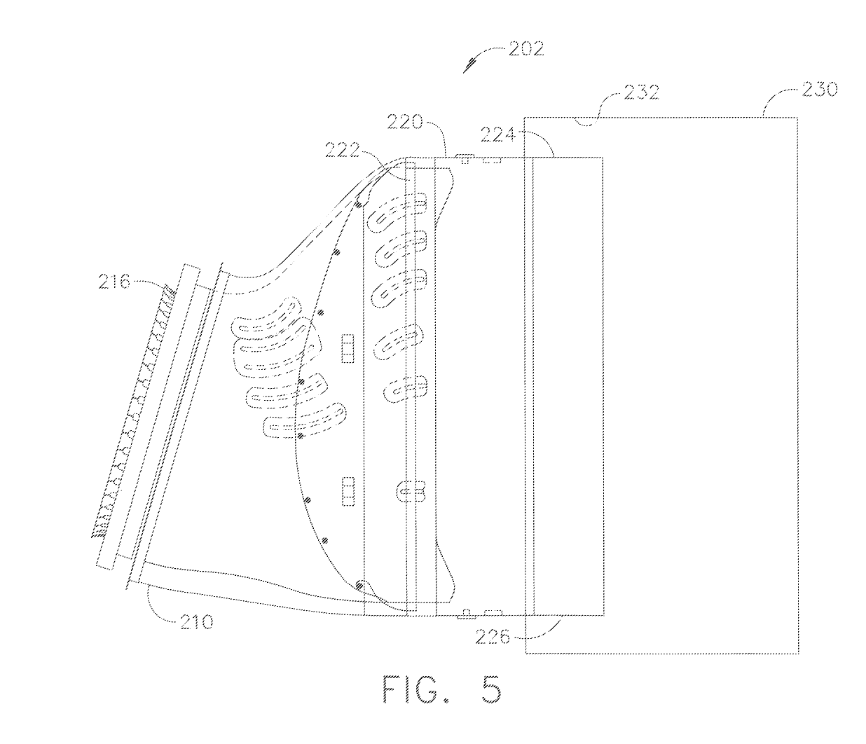

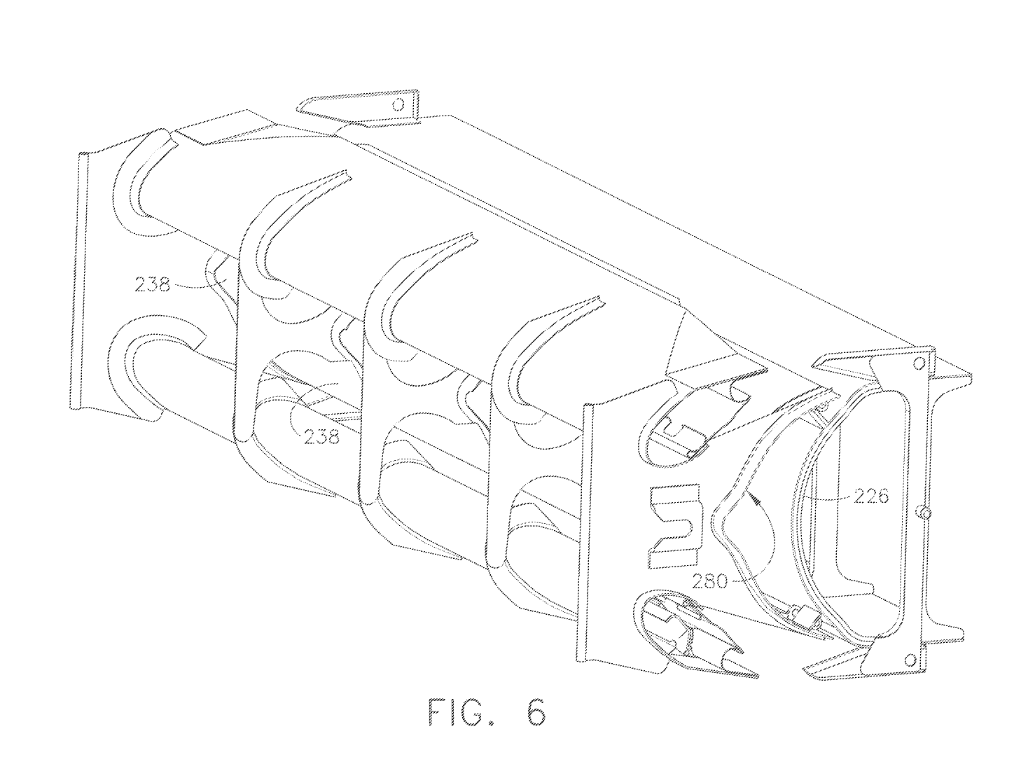

FIG. 5 is a cut-away view of the HIRSS of the present invention, showing the assembled deswirler 216 and the baffle assembly 222. The downstream end 224 of the second stage 220 forms a flange 226 that extends into or overlaps the upstream end 232 of the third stage 230. The coating of the present invention has been applied to the fore face 238 of the forward large baffle 280 as shown in FIG. 6.

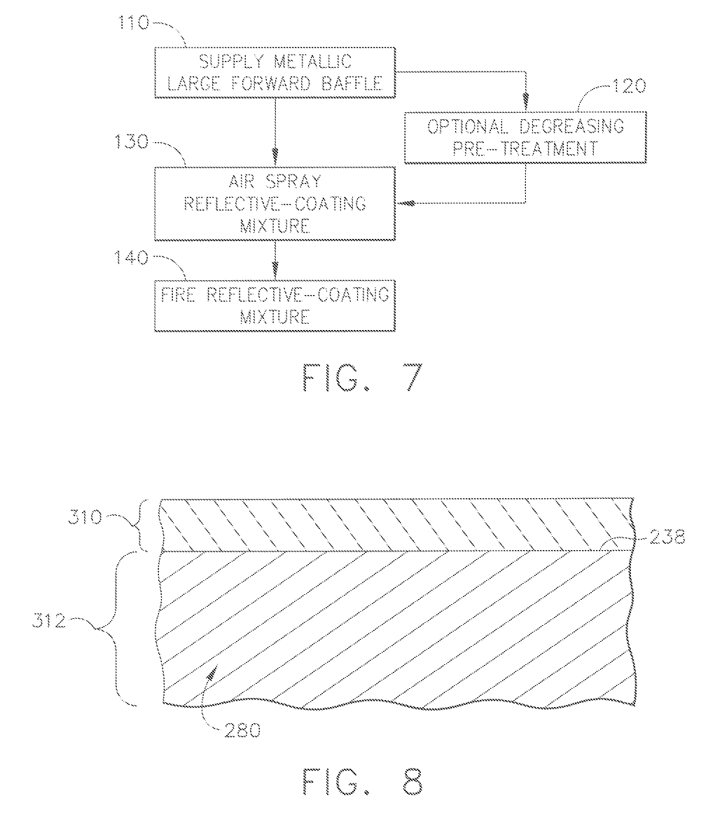

FIG. 7 depicts a preferred approach for applying a heat-rejection or highly reflective coating 310, and FIG. 8 (which is not drawn to scale) shows such a highly reflective coating 310 deposited on the fore face 238 of a high-temperature metallic large forward baffle 280, which serves as a substrate 312 for the heat-rejection coating 310. The high-temperature metallic large forward baffle 280 is supplied, numeral 110. The metallic large forward baffle 280 is preferably made of a nickel-base superalloy. Nickel-base superalloys are known in the art. A preferred nickel-base superalloy is INCONEL® 625, which is a known superalloy. INCONEL® is a federally registered trademark of Huntington Alloys Corporation of Huntington, W. Va. INCONEL® 625 has a nominal composition in weight percent of about 20 to about 23 percent chromium, of about 8 to about 10 percent molybdenum, of about 10 to about 12 percent cobalt, of about 3.15 to about 4.15 percent columbium, up to about 5 percent iron, up to about 1 percent cobalt, up to about 0.5 percent silicon, up to about 0.5 percent manganese up to about 0.4 percent titanium, up to about 0.4 percent aluminum, up to about 0.1 percent carbon, up to about 0.05 percent tantalum, up to about 0.015 percent sulfur, balance nickel, minor elements, and impurities. The present approach may be used with other components comprising high temperature alloys other than those set forth above.

The fore face 238 of the large forward baffle 280 optionally receives a degreasing pre-treatment, numeral 120, to form a pre-treated fore face 238. This degreasing pre-treatment is not necessary for the present invention. This degreasing pre-treatment removes any materials that may be present from previous processing of the large forward baffle 280, and is typically achieved by solvent wash and/or polishing, or lightly buffing, the component surface. The polishing is preferably accomplished using an air grinder with a commercially available SCOTCH-BRITE® pad, which is a registered trademark of Minnesota Mining and Manufacturing Company of St. Paul, Minn. This polishing removes any pre-existing grease, soot, and oxide scale.

In a preferred embodiment, the next step of the process 130 is air-spraying a reflective coating mixture onto the fore face 238 of the large forward baffle 280. The reflective-coating mixture comprises fine particles of a metallic pigment, such as platinum, platinum alloys, gold, gold alloys, and combinations thereof mixed with an organic reflective-coating-mixture carrier. A platinum/gold blend is preferred as the metallic pigment. It is preferred to apply the reflective-coating mixture in several layers, allowing each layer to flash off solvent before the next layer is applied. Each layer is allowed to flash off solvent at ambient temperature for a period of time in the range of about 5 minutes to about 60 minutes. The length of time that each layer is allowed to flash off solvent is dependent on the ambient environment and ambient air movement. Thus, drying can be accelerated by providing forced air circulation and/or increasing the air temperature.

Air-assisted spraying is a technique comparable to the familiar spraying of ordinary paint, and is typically performed at room temperature using an air-spray-gun type of device. The material to be sprayed, here the reflective coating, is not significantly heated during the spray process of the present invention (although it is heated subsequently in the firing step). Air-assisted spraying is to be contrasted with other spray techniques used to deposit other types of coatings in the gas turbine industry, such as vacuum plasma spraying and air plasma spraying, which are not within the scope of the invention. Plasma spray techniques are performed by heating the material to be sprayed to high temperatures and then forcing the heated material against the surface with a flow of the spray gas. Air-assisted spraying is also to be contrasted with other types of deposition techniques such as chemical vapor deposition, physical vapor deposition, and electrodeposition, all of which require complex deposition apparatus, and all of which are not within the scope of the invention. Most of these other application techniques are limited as to the size of the articles that may be readily coated, because they require special chambers or other types of application apparatus. Air-assisted spraying, on the other hand, is not limited by these considerations, and therefore may be readily used on a wide variety of sizes and shapes of components. Other room-temperature application techniques such as airless spray, brushing, and application by a decal transfer method may also be used in the present approach.

A suitable platinum-including reflective-coating mixture is Engelhard Spray Bright Platinum (“Spray Bright Platinum”), available from Engelhard Corporation, East Newark, N.J. The Spray Bright Platinum comprises in weight percent about 20 percent to about 30 percent metallo-organic platinum compounds, about 10 percent to about 20 percent essential oils, about 10 percent to about 20 percent ethyl acetate, about 10 percent to about 20 percent methyl benzoate, about 5 percent to about 10 percent camphor, about 5 percent to about 10 percent rosin, about 1 percent to about 5 percent benzyl acetate, and about 1 percent to about 5 percent metallo-organic bismuth compounds as the organic carrier and the balance at least about 5 percent turpentine.

A suitable gold-including reflective coating mixture is Liquid Bright Gold for Spraying (“Liquid Bright Gold”) available from Engelhard Corporation, East Newark, N.J. The Liquid Bright Gold material comprises in weight percent about 1 percent to about 10 percent platinum and gold compounds, about 20 percent to about 30 percent ethyl acetate, about 10 percent to about 20 percent heptane, about 5 percent to about 10 percent cyclohexane, about 5 percent to about 10 percent terpineol, and less than 2 percent of each of butyl carbitol acetate, propyl acetate, metallo-organic vanadium compounds, and essential oils and the balance at least about 20 percent turpentine.

Preferably, the reflective coating mixture is a blend of about 25 percent by weight Spray Bright Platinum with the balance being Liquid Bright Gold.

The air-spraying 130 is performed in ambient conditions, that is, in air, without heating either the flow of the mixture being sprayed or the substrate. It is readily performed quickly and inexpensively on the large forward baffle 280. Air-assisted spraying is contrasted with other types of deposition techniques often used to deposit coatings on gas turbine components, such as plasma spraying, vapor phase aluminiding, and chemical vapor deposition, all of which are performed at elevated temperatures and in most cases in special atmospheric chambers or devices. Air-assisted spraying is also contrasted with electrodeposition and dipping techniques, which require that the article be immersed in a liquid medium. Alternative approaches which are within the scope of the present invention are HVLP airless spraying, brushing, and decal transfer application. It is preferred that the air spraying 130 applies the reflective-coating mixture in several layers, allowing each layer to flash off solvent before the next layer is applied.

The large forward baffle 280 having the reflective-coating mixture thereon is thereafter fired to form a reflective coating 310, numeral 140. The firing 140 is performed by heating the reflective-coating mixture to an elevated temperature in air. A preferred temperature range is from about 1,000° F. (538° C.) to about 1800° F. (982° C.) for a period of time in the range of about 0.5 hours to about 4 hours. The preferred approach is to heat the entire large forward baffle 280 and the applied coating 310 to the firing temperature.

The reflective coating 310 is applied in an amount to provide complete coverage of the substrate such that the total amount of the reflective coating 72 is present in an amount of about 0.00275 to about 0.00475 grams per square inch of the component surface being coated.

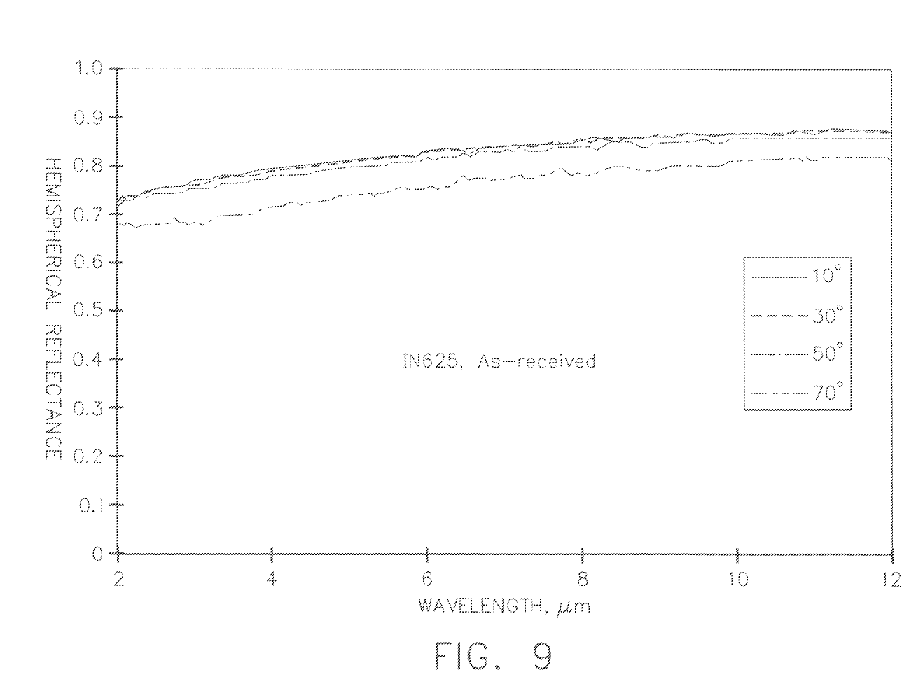

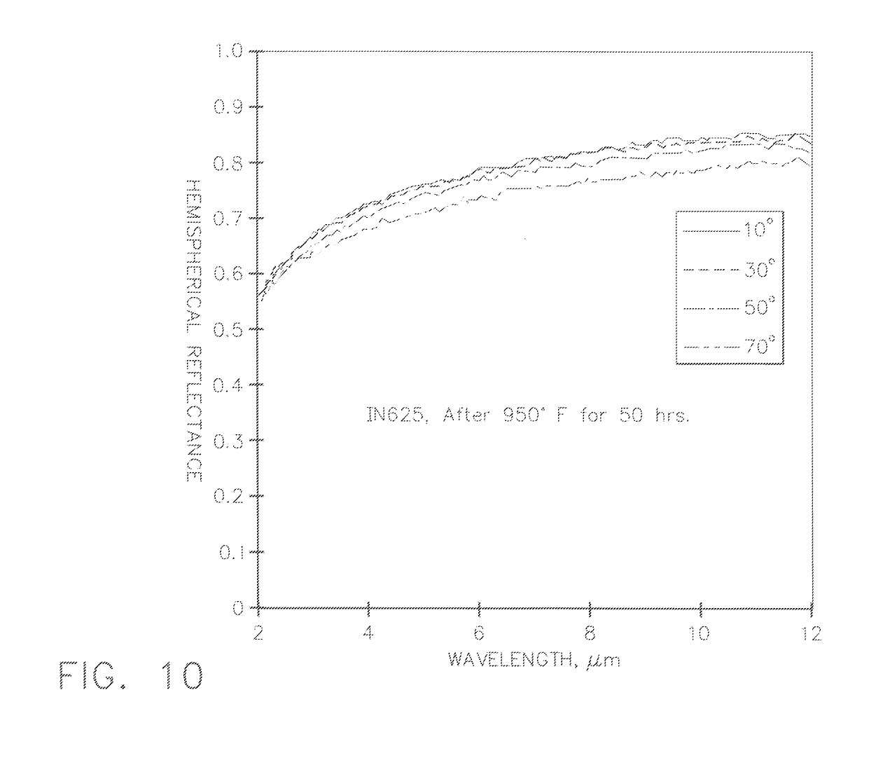

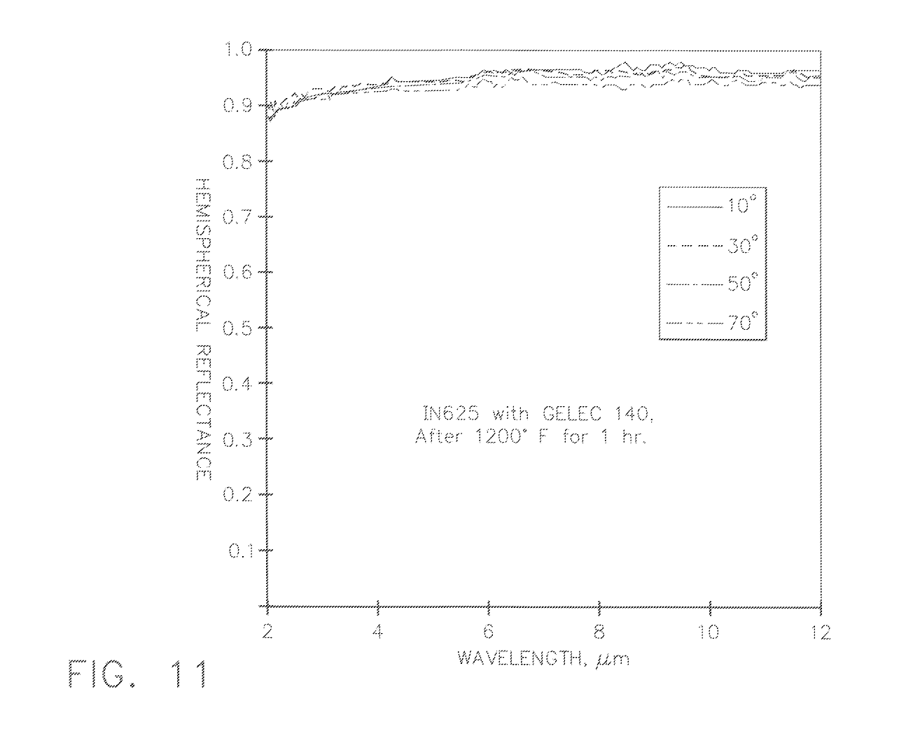

The performance of the coating in reducing IR is presented in FIG. 9, FIG. 10, and FIG. 11 as graphs of hemispherical reflectance vs. wavelength, where wavelength is the wavelength of the infrared radiation. These graphs represent both infrared radiation reflected by an article as well as infrared radiation incident on the article and reflected from it. The infrared radiation was measured at angles of 10°, 30°, 50°, and 70°, as measured perpendicular to the surface. FIG. 9 depicts the hemispherical reflectance of IR (infrared radiation) of INCONEL® 625 in the as received condition in the range of about 2-12 μm. INCONEL® 625 was selected as the superalloy material as this material is the preferred and primary material used for the HIRSS, although the behavior of other metallic materials is expected to be about the same. There is limited change in hemispherical reflectance from the material across the IR band from 2 μm to about 12 μm. As the graph indicates, INCONEL® 625 is a good reflector of IR in this wavelength range. However, in order to reduce the overall IR signature of the engine, the reflectance of INCONEL® 625 must be increased.

FIG. 9 differs from FIG. 10 in that it displays the hemispherical reflectance of INCONEL® 625 after 50 hours at 950° F. As indicated in the graph, the reflectivity of the INCONEL® 625 is degraded at these temperatures in the 2-12 micron range, although there is a larger decrease in hemispherical reflectance (reflectivity) in the 2-4 micron range. In both FIGS. 9 and 10, reflectance decreases as the angle of observation or measurement deviates from perpendicular. That is, hemispherical reflectance is lower as observed at 70° then at 10°.

FIG. 11 is a graph of hemispherical reflectance of an INCONEL® 625 sample coated with the coating of the present invention. This coating is identified as GELEC 140. This graph indicates that the hemispherical reflectance of the sample is increased from about 70-80% for an uncoated sample of INCONEL® 625, as indicated by FIG. 9 to over 90% as indicated in FIG. 11, although it drops slightly below 90% in the 2-3 micron range. As is illustrated in FIG. 11, the reflectance is substantially the same at all angles observed. The coated sample retained its low emissivity after elevated thermal exposures.

Thermal analysis indicates that the use of the coating of the present invention, GELEC 140, on a selected area of a HIRSS, as set forth above, installed in a gas turbine engine, such as the GE T-700, reduces engine IR signature. A demonstration HIRSS system coated with GELEC 140 coating on selected surfaces, as set forth above, and an uncoated HIRSS system were tested on an aircraft. The uncoated HIRSS formed the baseline for measuring the IR from the aircraft. Measured system IR reduction from the coated HIRSS as compared to the uncoated IR showed substantial reductions in emissivity. The GELEC 140 coating provides a substantial reduction to the IR signature when applied to selected surfaces of a HIRSS system as set forth above.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A hover infrared suppression system for a gas turbine engine comprising:
a hover infrared suppression system having an upstream first stage, a second stage downstream of the first stage and a third stage downstream of the second stage, the engine operating at a temperature sufficient to cause the hover infrared suppression system to emit infrared radiation; and
a high reflectivity coating applied over a preselected area of at least one of the stages of the hover infrared suppression system to reduce the infrared radiation emitted from the engine, the high reflectivity coating being fired after application.

2. The hover infrared suppression system of claim 1, wherein the high reflectivity coating, as applied, comprises a platinum-including and gold-including coating mixture.

3. The hover infrared suppression system of claim 2, wherein the coating mixture in weight percent about 25 percent platinum-including coating mixture and the balance gold-including coating mixture.

4. The hover infrared suppression system of claim 3, wherein the platinum-including coating mixture, as applied, comprises in weight percent about 20 percent to about 30 percent metallo-organic platinum compounds, about 10 percent to about 20 percent essential oils, about 10 percent to about 20 percent ethyl acetate, about 10 percent to about 20 percent methyl benzoate, about 5 percent to about 10 percent camphor, about 5 percent to about 10 percent rosin, about 1 percent to about 5 percent benzyl acetate, and about 1 percent to about 5 percent metallo-organic bismuth compounds as the organic carrier and the balance at least about 5 percent turpentine.

5. The hover infrared suppression system of claim 3, wherein the gold-including coating mixture, as applied, comprises in weight percent about in weight percent about 1 percent to about 10 percent platinum and gold compounds, about 20 percent to about 30 percent ethyl acetate, about 10 percent to about 20 percent heptane, about 5 percent to about 10 percent cyclohexane, about 5 percent to about 10 percent terpineol, and less than 2 percent of each of butyl carbitol acetate, propyl acetate, metallo-organic vanadium compounds, and essential oils and the balance at least about 20 percent turpentine.

6. The hover infrared suppression system of claim 1, wherein the high reflectivity coating mixture is applied to the second stage of the hover infrared suppression system, wherein the second stage is intermediate between the upstream first stage, the second stage including a large forward baffle.

7. The hover infrared suppression system of claim 6, wherein the high reflectivity coating is applied to a surface of the large forward baffle.

8. The hover infrared suppression system of claim 7, wherein the high reflectivity coating is applied to a fore face of the large forward baffle.

9. The hover infrared suppression system of claim 7, wherein the large forward baffle comprises a nickel-base superalloy.

10. The hover infrared suppression system of claim 9, wherein the nickel-base superalloy has a nominal composition in weight percent of about 20 to about 23 percent chromium, of about 8 to about 10 percent molybdenum, of about 10 to about 12 percent cobalt, of about 3.15 to about 4.15 percent columbium, up to about 5 percent iron, up to about 1 percent cobalt, up to about 0.5 percent silicon, up to about 0.5 percent manganese up to about 0.4 percent titanium, up to about 0.4 percent aluminum, up to about 0.1 percent carbon, up to about 0.05 percent tantalum, up to about 0.015 percent sulfur, balance nickel, minor elements, and impurities.

11. The hover infrared suppression system of claim 1, wherein the high reflectivity coating is present in an amount in the range of about 0.00275 to about 0.00475 grams per square inch of the preselected area after firing.

12. A large forward baffle for a hover infrared suppression system comprising:
a large forward baffle having a fore face; and
a noble metal coating on a preselected area of the fore face, the noble metal coating being present in an amount in the range of about 0.00275 to about 0.00475 grams per square inch of the preselected area.

13. The large forward baffle of claim 12, wherein the noble metal coating is selected from the group consisting of platinum, platinum alloys, gold, gold alloys, and combinations thereof.

14. The large forward baffle of claim 12, wherein the large forward baffle comprises a nickel-base superalloy.

15. The large forward baffle of claim 14, wherein the large forward baffle comprises a nickel-base alloy having a nominal composition in weight percent of about 20 to about 23 percent chromium, of about 8 to about 10 percent molybdenum, of about 10 to about 12 percent cobalt, of about 3.15 to about 4.15 percent columbium, up to about 5 percent iron, up to about 1 percent cobalt, up to about 0.5 percent silicon, up to about 0.5 percent manganese up to about 0.4 percent titanium, up to about 0.4 percent aluminum, up to about 0.1 percent carbon, up to about 0.05 percent tantalum, up to about 0.015 percent sulfur, balance nickel, minor elements, and impurities.

16. The large forward baffle of claim 14, wherein the large forward baffle comprises a nickel-base alloy having a nominal composition in weight percent of about 20 to about 23 percent chromium, of about 8 to about 10 percent molybdenum, of about 10 to about 12 percent cobalt, of about 3.15 to about 4.15 percent columbium, up to about 5 percent iron, up to about 1 percent cobalt, up to about 0.5 percent silicon, up to about 0.5 percent manganese up to about 0.4 percent titanium, up to about 0.4 percent aluminum, up to about 0.1 percent carbon, up to about 0.05 percent tantalum, up to about 0.015 percent sulfur, balance nickel, minor elements, and impurities
